(19) United States
(12) Patent Application Publication
(10) Pub. No.: US 2015/0251358 A1
(43) Pub. Date: Sep. 10, 2015

(54) THREE DIMENSIONAL PRINTING APPARATUS AND METHOD FOR CONTROLLING PRINTING HEAD THEREOF

(71) Applicants: XYZprinting, Inc., New Taipei City (TW); Kinpo Electronics, Inc., New Taipei City (TW); Cal-Comp Electronics & Communications Company Limited, New Taipei City (TW)

(72) Inventors: Kwan Ho, New Taipei City (TW); Chien-Hung Tung, New Taipei City (TW)

(73) Assignees: XYZprinting, Inc., New Taipei City (TW); Kinpo Electronics, Inc., New Taipei City (TW); Cal-Comp Electronics & Communications Company Limited, New Taipei City (TW)

(21) Appl. No.: 14/284,397

(22) Filed: May 22, 2014

(30) Foreign Application Priority Data
Mar. 7, 2014 (TW) 103107954

(51) Int. Cl. B29C 67/00

(52) U.S. Cl. CPC B29C 67/0088; B29C 67/0055; B33Y 10/00; B33Y 30/00; B33Y 50/02

(57) ABSTRACT

A three-dimensional printing apparatus and a method for controlling printing head thereof are provided. The method is used for controlling a moving path of a printing head of the three-dimensional printing apparatus and the method includes following steps. The printing head is controlled to form a layer object on a carrying surface according to three-dimensional model information. It is determined whether a cross-section parameter of the layer object is match to a small range condition. If the cross-section parameter of the layer object is match to the small range condition, the printing head is controlled to move toward a first direction far away from layer object according to position information of the layer object. The printing head is controlled to move toward a second direction close to the layer object.

### CROSS-REFERENCE TO RELATED APPLICATION

This application claims the priority benefit of Taiwan application serial no. 103107954, filed on Mar. 7, 2014. The entirety of the above-mentioned patent application is hereby incorporated by reference herein and made a part of this specification.

### BACKGROUND

1. Technical Field

The technical field relates to a printing apparatus and a method for controlling printing head, and particularly relates to a three-dimensional (3D) printing apparatus and a method for controlling printing head thereof.

2. Related Art

In recent years, along with quick development of technology, methods for constructing three-dimensional (3D) models by using an additive manufacturing technique to construct model layer-by-layer have been provided. Generally, the additive manufacturing technique is to convert design data of a 3D model constructed by software such as computer aided design (CAD) etc. into a plurality of continuously stacked thin (quasi-two-dimensional) cross-section layers. In this way, a printing module of a 3D printing apparatus can move along an XY plane above a printing platform according to spatial coordinates XYZ constructed by the design data of the 3D model, so as to construct a correct shape of the cross-section layer via a constructing material. Then, the printing module moves layer-by-layer along a Z-axis direction to gradually stack the cross-section layers along the Z-axis, so as to form a 3D object as the constructing material is cured layer-by-layer.

Presently, in the 3D printing apparatus that produces the 3D object according to the aforementioned rapid prototyping method, the printing head is generally heated to melt a molding material, and coat the same on the printing platform layer-by-layer to construct the 3D object. Generally, a time spent when the printing head moves on the XY plane is just adequate for the molding material coated on the printing platform to become cured or hardened to a certain degree, such that the high-temperature and melted molding material may form the 3D object as the molding material is cured layer-by-layer. Therefore, if a cross-section area of a layer object is excessively small, since the printing head is unnecessary to spend time to conduct a significant movement, a curing time of the layer object during the printing process is inadequate. In other words, when a layer object with a small cross-section area is printed, the printing head probably covers the high-temperature and melted molding material on the molding material that is still not cured to a certain degree on the printing platform, which may result in a fact that the shape of the printed 3D object is not as good as expected, such that printing quality and printing yield of the 3D printing apparatus are decreased.

### SUMMARY

One of the exemplary embodiments is directed to a three-dimensional (3D) printing apparatus and a method for controlling printing head thereof, by which printing quality of the 3D printing apparatus for printing a 3D object with a small cross-section area is improved.

One of exemplary embodiments provides a method for controlling printing head, which is used for controlling a moving path of a printing head of a three dimensional (3D) printing apparatus, and the method includes following steps. The printing head is controlled according to 3D model information so as to form a layer object on a carrying surface. It is determined whether a cross-section parameter of the layer object is matched to a small range condition. If the cross-section parameter of the layer object is matched to the small range condition, the printing head is controlled to move toward a first direction away from the layer object according to position information of the layer object. Then, the printing head is controlled to move toward a second direction close to the layer object.

According to another aspect, one of exemplary embodiments provides a three-dimensional printing apparatus including a platform, a printing head and a control unit. The platform includes a carrying surface, and the printing head is disposed above the platform. The printing head is configured to move along a moving plane and move along a normal direction of the moving plane. The control unit is coupled to the platform and the printing head. The control unit controls the printing head to form a layer object on the carrying surface according to 3D model information, and determines whether a cross-section parameter of the layer object is matched to a small range condition. If the cross-section parameter of the layer object is matched to the small range condition, the control unit controls the printing head to move toward a first direction away from the layer object according to position information of the layer object, and controls the printing head to move toward a second direction close to the layer object.

According to the above descriptions, in the embodiments, it is determined whether a printing scope of the layer object belongs to a small scope by detecting the cross-section parameter of the layer object. When the layer object with a small cross-section area is detected, in order to reserve enough curing time for the layer object with a small cross-section area, the printing head moves toward a direction away from the layer object. After the printing head moves toward the direction away from the layer object by a predetermined distance, the printing head moves back to a position capable of printing a next layer object. In this way, by moving the printing head, the layer object with small cross-section area may have enough time for curing to a certain decree, so as to avoid continuous addition of a molding material under a state of incomplete curing. In this way, a situation that the printed 3D object is not as good as expected is avoided, and printing quality of the 3D printing apparatus is improved.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block schematic diagram of a working status of a three-dimensional (3D) printing apparatus according to an exemplary embodiment.

FIG. 2 is a block schematic diagram of a 3D printing apparatus according to exemplary embodiment.

FIG. 3 is a schematic diagram of a 3D printing apparatus according to an exemplary embodiment.

FIG. 4 is a flowchart illustrating a method for controlling printing head according to an exemplary embodiment.

FIG. 5 is a flowchart illustrating a method for controlling printing head according to another exemplary embodiment.

FIG. 6 is a schematic diagram of a cross-section of a layer object on an XY plane according to an exemplary embodiment.

FIG. 7A is an example of a method for controlling printing head according to an exemplary embodiment.

FIG. 7B is an example of a method for controlling printing head according to an exemplary embodiment.

FIG. 8 is a schematic diagram of a 3D printing apparatus according to an exemplary embodiment.

FIG. 9 is a flowchart illustrating a method for controlling printing head according to another exemplary embodiment.

### DETAILED DESCRIPTION OF DISCLOSED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

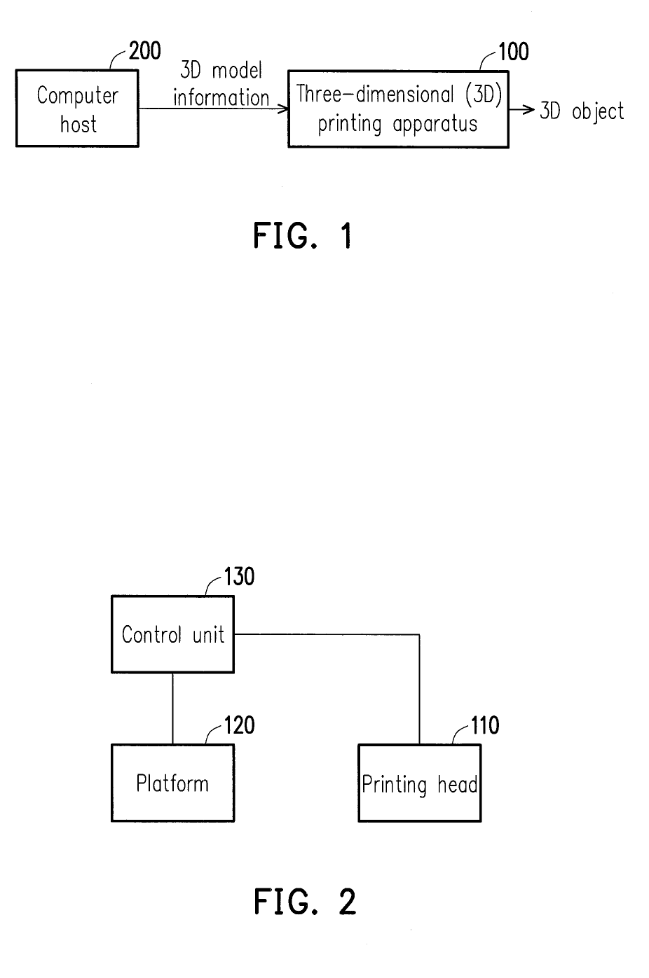

FIG. 1 is a block schematic diagram of a working status of a three-dimensional (3D) printing apparatus according to an exemplary embodiment. Referring to FIG. 1, the 3D printing apparatus 100 of the present embodiment is adapted to print a 3D object according to 3D model information. Further, a computer host 200 is a device having a computation function, such as a notebook computer, a tablet personal computer (PC), or a desktop computer, etc., and the type of the computer host 200 is not limited by the disclosure. The computer host 200 can edit and process a 3D model of a 3D object, and transmit related 3D model information to the 3D printing apparatus 100, such that the 3D printing apparatus 100 can print the 3D object according to the 3D model information. In the embodiment, the 3D model information can be a 3D digital image file, which can be created by the computer host 200 by using software such as computer-aided design (CAD) or animation modelling software, etc., and the 3D model information can be sliced into a plurality pieces of cross-section information. In this way, the 3D printing apparatus 100 can sequentially print a plurality of layer objects according to the cross-section information of the 3D model information, and the layer objects are stacked to form the 3D object.

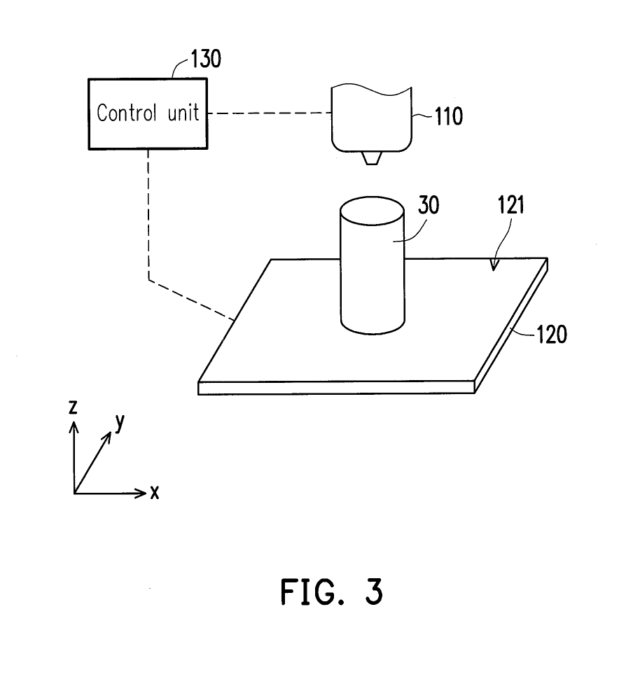

FIG. 2 is a block schematic diagram of a 3D printing apparatus according to an exemplary embodiment. FIG. 3 is a schematic diagram of the 3D printing apparatus according to an exemplary embodiment. Referring to FIG. 2 and FIG. 3, in the present embodiment, the 3D printing apparatus 100 includes a printing head 110, a platform 120 and a control unit 130. Meanwhile, a Cartesian coordinate system is provided to facilitate describing related components and motion states thereof. The platform 120 includes a carrying surface 121. The printing head 110 is disposed above the platform 120, and the printing head 110 is configured to move along an XY plane and move along a normal direction (a Z-axis direction) of the XY plane, so as to print the layer objects on the carrying surface 121 layer-by-layer to gradually form a 3D object 30.

Further, in the present embodiment, a molding material used for forming the 3D object 30 can be various materials suitable for a manufacturing method such as fused filament fabrication (FFF) or melted and extrusion modelling, etc. For example, the molding material is a hot melt wire suitable for the fused filament fabrication, and is heated by the printing head 110, such that the molding material sent to the printing head 110 is melted to form a fluid material in a melting state, and then the printing head 110 squeezes the high-temperature and melted molding material. In this way, the melted molding material can be cured on the carrying surface 121 layer-by-layer to form the 3D object 30.

Moreover, the control unit 130 is coupled to the printing head 110 and the platform 120 for reading the 3D model information, and controls a whole operation of the 3D printing apparatus 100 according to the 3D model information to print the 3D object 30. For example, the control unit 130 can control a moving path of the printing head 110 according to the 3D digital model information. The control unit 130 is, for example, a device having a computation function such as a central processor, a chipset, a microprocessor, an embedded controller, etc., which is not limited by the disclosure.

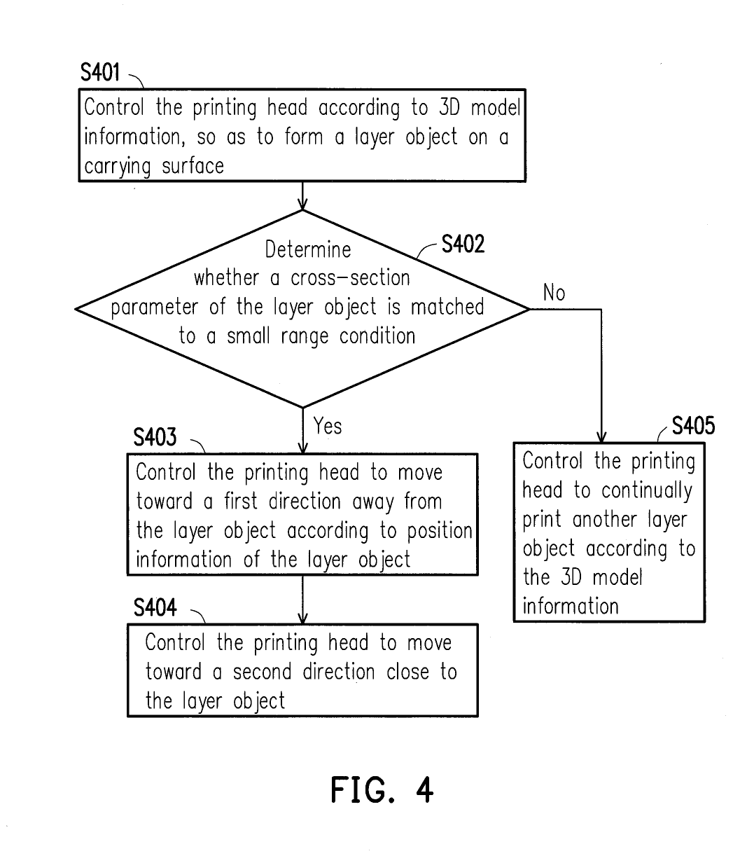

FIG. 4 is a flowchart illustrating a method for controlling printing head according to an exemplary embodiment. The method of the present embodiment is adapted to the 3D printing apparatus of FIG. 2 and FIG. 3, and details of the method for controlling printing head are described below with reference of various components of the 3D printing apparatus 100.

Referring to FIG. 4, in step S401, the control unit 130 controls the printing head 110 to form a layer object on the carrying surface 121 according to 3D model information. Namely, the control unit 130 receives the 3D model information from the computer host 200, and controls various components of the 3D printing apparatus 100 to print a layer object. In other words, the 3D object printed by the 3D printing apparatus 100 is composed of a plurality of layer objects, and each of the layer objects has a cross-section corresponding to a profile of the 3D object. The control unit 130 controls the moving path of the printing head 110 to print the layer objects according to the 3D model information, and stacks the layer objects on the carrying surface 121 layer-by-layer from bottom to top (along the Z-axis direction) to form the 3D object.

In step S402, the control unit 130 determines whether a cross-section parameter of the layer object is matched to a small range condition. In detail, the control unit 130 determines whether the printing head 110 only performs a small range movement on the moving plane (the XY plane) when the printing head 110 prints the layer objects. For example, during a process that the 3D printing apparatus 100 prints a slender pillar, a portion of the printing head 110 on the XY plane is not obviously changed. Therefore, according to the cross-section parameter of each layer object, the control unit 130 is aware that the printing head 110 only performs a small range movement on the XY plane when the printing head 110 prints the layer objects of the slender pillar.

In the present embodiment, the cross-section parameter of the layer object includes a total printing time of the layer object. Namely, the total printing time is the time spent when the printing head 110 prints the whole layer object. It is known that if the printing head 110 only performs a small range movement on the XY plane when printing the layer object, the total printing time of the layer object is relatively short. Comparatively, if the printing head 110 performs a large range movement on the XY plane when printing the layer object, the total printing time of the layer object is relatively long. In this way, the control unit 130 can determine whether the cross-section parameter of the layer object is matched to the small range condition according to whether the total printing time is smaller than or equal to a time threshold. Namely, the control unit 130 can be aware whether the printing head 110 performs the small range movement above the carrying surface 121 according to the total printing time of the layer object.

It should be noticed that the disclosure is not limited to determine whether the cross-section parameter of the layer object is matched to the small range condition according to the total printing time. In another embodiment, the cross-section parameter of the layer object includes a total cross-section area of the layer object. In detail, the total cross-section area can be regarded as a cover range of the layer object on the XY plane. Therefore, if the printing head 110 only performs a small range movement on the XY plane when printing the layer object, the total cross-section area of the layer object is relatively small. Comparatively, if the printing head 110 performs a large range movement on the XY plane when printing the layer object, the total cross-section area of the layer object is relatively large. In this way, the control unit 130 can determine whether the cross-section parameter of the layer object is matched to the small range condition according to whether the total cross-section area is smaller than or equal to an area threshold. Namely, the control unit 130 can be aware whether the printing head 110 performs the small range movement above the carrying surface 121 according to the total cross-section area of the layer object.

In another embodiment, the cross-section parameter of the layer object includes a moving distance corresponding to the printing head 110 of the layer object. In other words, the moving distance represents a length of a moving path of the printing head 110 when printing the layer objects. Therefore, if the printing head 110 only performs a small range movement on the XY plane when printing the layer object, the moving distance is relatively short. Comparatively, if the printing head 110 performs a large range movement on the XY plane when printing the layer object, the moving distance is relatively large. In this way, the control unit 130 can determine whether the cross-section parameter of the layer object is matched to the small range condition according to whether the moving distance is smaller than or equal to a length threshold. Namely, the control unit 130 can be aware whether the printing head 110 performs the small range movement above the carrying surface 121 according to the length of the moving path of the printing head 110.

Then, if the cross-section parameter of the layer object is not matched to the small range condition, in step S405, the control unit 130 controls the printing head 110 to continually print another layer object according to the 3D model information. Comparatively, if the cross-section parameter of the layer object is matched to the small range condition, in step S403, the control unit controls the printing head 110 to move toward a first direction away from the layer object according to position information of the layer object. In detail, via a period of time spent for controlling the printing head 110 moves toward the first direction, the molding material of the layer object has enough time to be cured to a certain degree, so as to avoid stacking the molding material that is not cured to the certain degree to produce a 3D object that is not as good as expected. Namely, before the printing head 110 moves to a next position along the Z-axis direction to print another layer object, the molding material on the carrying surface has been cured to a certain degree.

Then, in step S404, the control unit 130 controls the printing head 110 to move toward a second direction close to the layer object. In the present embodiment, the first direction can be opposite to the second direction. Namely, after the control unit 130 controls the printing head 110 to move to a first position along the first direction, the control unit 130 controls the printing head 110 to move back to the top of the layer object from the first position along a direction opposite to the first direction, so as to facilitate the printing head 110 to continually stack another layer object on the layer object. However, the disclosure is not limited thereto, and the control unit 130 can determine the second direction according to an actual application or according to the 3D model information, so as to control the printing head 110 to move toward the first direction and then move toward the second direction.

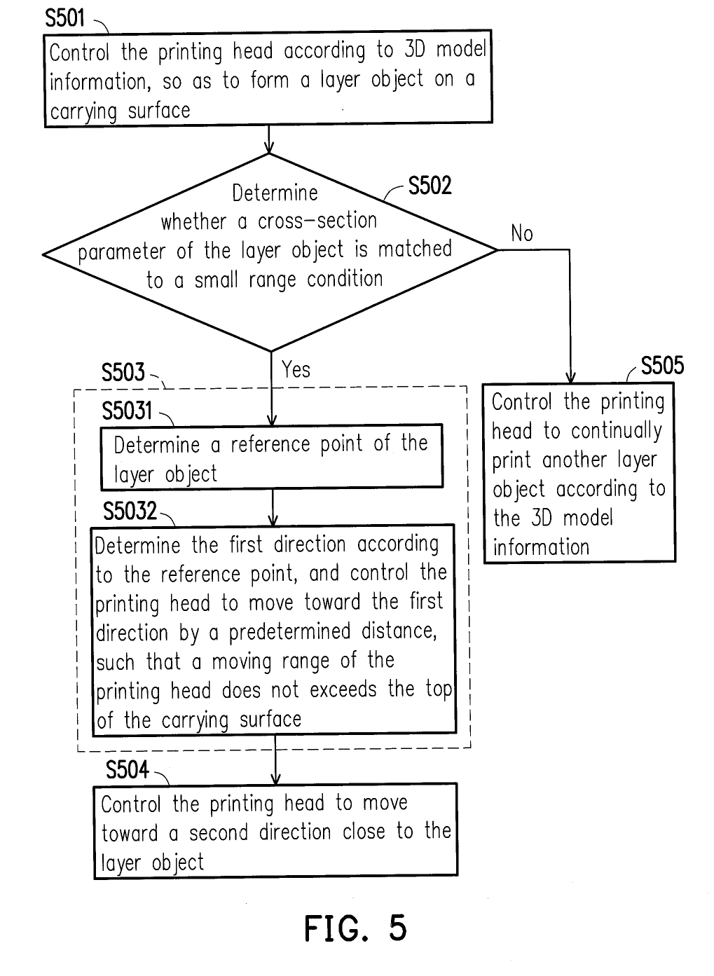

In order to describe the disclosure in detail, another embodiment is provided below to describe how the control unit controls a moving path of the printing head when the 3D printing apparatus performs a small range printing. FIG. 5 is a flowchart illustrating a method for controlling printing head according to another exemplary embodiment. The method of the present embodiment is adapted to the 3D printing apparatus of FIG. 2 and FIG. 3, and detailed steps of the method for controlling printing head of the present embodiment are described below with reference of various components of the 3D printing apparatus 100.

Referring to FIG. 5, in step S501, the control unit 130 controls the printing head 110 to form a layer object on the carrying surface 121 according to 3D model information. In step S502, the control unit 130 determines whether a cross-section parameter of the layer object is matched to a small range condition. If a determination result of the step S502 is negative, in step S505, the control unit 130 controls the printing head 110 to continually print another layer object according to the 3D model information. The above steps S501, S502 and S505 are similar or the same with the steps S401, 402 and S405 of the embodiment of FIG. 4, so that details thereof are not repeated.

On the other hand, if the cross-section parameter of the layer object is matched to the small range condition, in step S503, the control unit controls the printing head 110 to move toward a first direction away from the layer object according to position information of the layer object. Then, in step S504, the control unit 130 controls the printing head 110 to move toward a second direction close to the layer object.

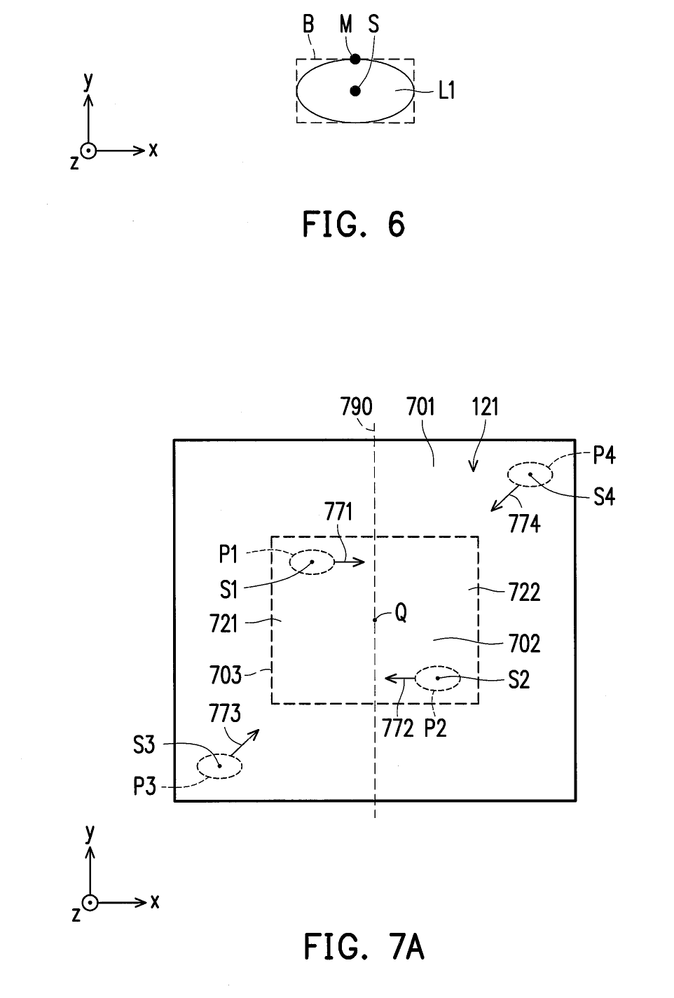

In detail, in the present embodiment, the step S503 may include a sub step S5031 and a sub step S5032. In order to determine the moving path of the printing head 110, in the step S5031, the control unit 130 first determines a reference point of the layer object. For example, FIG. 6 is a schematic diagram of a cross-section of the layer object on the XY plane according to an exemplary embodiment. Referring to FIG. 6, the control unit 130 takes a center point S of a bounding box B of a layer object L1 on the XY plane as the reference point of the layer object L1, and takes a position of the reference point S as a position of the layer object L1, so a to further determine a method of moving the printing head 110. However, the disclosure is not limited thereto, and in other embodiments, the control unit 130 can also determine the reference point of the layer object according to other methods. For example, the control unit 130 can also select an edge point M of the layer object L1 that has a maximum Y-axis coordinate value to serve as the reference point of the layer object L1.

Then, in step S5032, the control unit 130 determines the first direction according to the position of the reference point, and controls the printing head 110 to move toward the first direction by a predetermined distance, where a moving range of the printing head 110 does not exceeds the top of the carrying surface 121. The predetermined distance is a predetermined value, which is determined according to an actual application, and the disclosure is not limited thereto. For example, when a length and a width of the carrying surface are all 20 cm, the predetermined distance is, for example, 5 cm.

It should be noticed that although the layer object with a small printing range has enough time for curing as the printing head 110 moves by the predetermined distance, though in order to avoid prolonging the whole printing time due to significant movement of the printing head 110, the predetermined distance can be determined according to a curing time required by the molding material. In other words, the predetermined distance can be determined according to a type of the molding material. Moreover, in the present embodiment, in order to control the moving range of the printing head 110 to be within the range of the carrying surface 121, the control unit 130 can determine the first direction of moving the printing head 110 according to the position of the layer object on the XY plane.

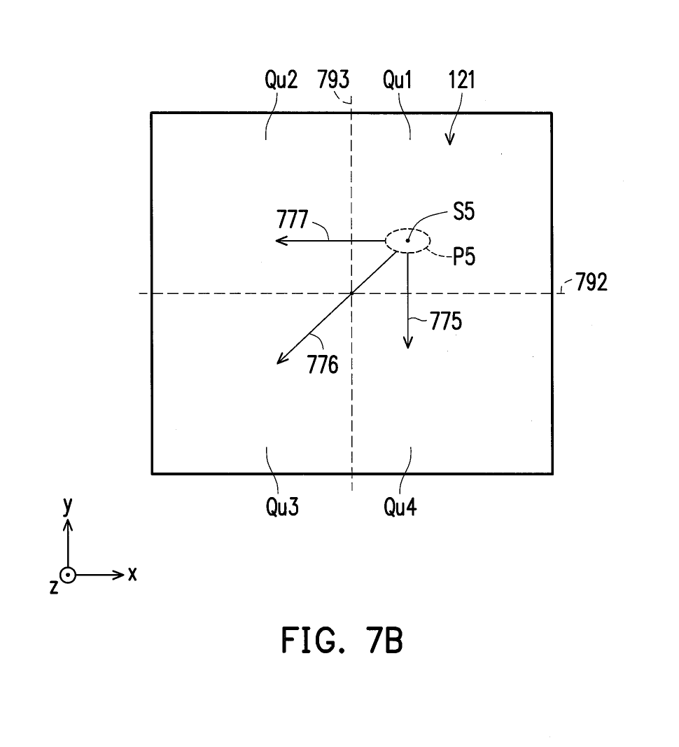

For example, FIG. 7A is an example of a method for controlling printing head according to an exemplary embodiment. In this example, it is assumed that the control unit 130 takes a center point of a bounding box of a layer object on the XY plane as the reference point of the layer object. Referring to FIG. 7A, the carrying surface 121 is divided into an inner block 702 and an outer block 701 by dividing lines 703, and the inner block 702 is divided into a left part 721 and a right part 722 by a central dividing line 790. In the present example, the control unit 130 determines whether a projection position of the reference point of the layer object on the carrying surface 121 is located in the inner block 702 or the outer block 701 of the carrying surface 121, so as to determine the first direction for moving the printing head 110.

In detail, if the projection position of the reference point is located in the outer block 701, the control unit 130 controls the printing head 110 to move toward a center point Q of the carrying surface 121 on the XY plane by a predetermined distance. If the projection position of the reference point is located in the inner block 702, the control unit 130 controls the printing head 110 to move along a first horizontal direction or a second horizontal direction on the XY plane by the predetermined distance.

To be specific, in the example of FIG. 7A, if the layer object is located at a position P1, the reference point of the layer object is projected to the carrying surface 121 at a projection position S1, and the control unit 130 determines that the projection position S1 is located in the inner block 702. Therefore, after the control unit 130 controls the printing head 110 to complete printing the layer object located at the position P1, the control unit 130 controls the printing head 110 to move along a first horizontal direction 771 on the XY plane by a predetermined distance.

If the layer object is located at a position P2, the reference point of the layer object is projected to the carrying surface 121 at a projection position S2, and the control unit 130 determines that the projection position S2 is located in the inner block 702. Therefore, after the control unit 130 controls the printing head 110 to complete printing the layer object located at the position P2, the control unit 130 controls the printing head 110 to move along a second horizontal direction 772 on the XY plane by the predetermined distance.

Further, if the projection position of the reference point is located in the left part 721 of the inner block 702, the control unit 130 controls the printing head 110 to move toward the central dividing line 790 along the first horizontal direction 771 by the predetermined distance on the XY plane. If the projection position of the reference point is located in the right part 722 of the inner block 702, the control unit 130 controls the printing head 110 to move toward the central dividing line 790 along the second horizontal direction 772 by the predetermined distance on the XY plane. As shown in FIG. 7A, the first horizontal direction 771 is opposite to the second horizontal direction 772, where the first horizontal direction 771 is a +X-axis direction and the second horizontal direction 772 is a −X-axis direction.

On the other hand, if the layer object is located at the position P3, the reference point of the layer object is projected to the carrying surface 121 at a projection position S3, and the control unit 130 determines that the projection position S3 is located in the outer block 701. Therefore, after the control unit 130 controls the printing head 110 to complete printing the layer object located at the position P3, the control unit 130 controls the printing head 110 to move toward the center point Q of the carrying surface 121 by a predetermined distance on the XY plane. In other words, the control unit 130 controls the printing head 110 to move along a first direction 773 by the predetermined distance on the XY plane.

If the layer object is located at the position P4, the reference point of the layer object is projected to the carrying surface 121 at a projection position S4, and the control unit 130 determines that the projection position S4 is located in the outer block 701. Therefore, after the control unit 130 controls the printing head 110 to complete printing the layer object located at the position P4, the control unit 130 controls the printing head 110 to move toward the center point Q of the carrying surface 121 by a predetermined distance on the XY plane. In other words, the control unit 130 controls the printing head 110 to move along a second direction 774 by the predetermined distance on the XY plane. However, the moving manner of the printing head is not limited to the example of FIG. 7A.

For example, FIG. 7B is an example of a method for controlling printing head according to an exemplary embodiment. In this example, it is assumed that the control unit 130 takes a center point of a bounding box of a layer object on the XY plane as the reference point of the layer object. Referring to FIG. 7B, in the present example, the carrying surface 121 is divided into a first quadrant block Qu1, a second quadrant block Qu2, a third quadrant block Qu3 and a fourth quadrant block Qu4 by a horizontal dividing line 792 and a vertical dividing line 793. The control unit 130 first determines whether a projection position of the reference point of the layer object on the carrying surface 121 is located in the first quadrant block Qu1, the second quadrant block Qu2, the third quadrant block Qu3 or the fourth quadrant block Qu4, and accordingly determines the first direction for moving the printing head 110.

In detail, in the example of FIG. 7B, if the layer object is located at a position P5, the reference point of the layer object is projected to a projection position S5 on the carrying surface 121, and the control unit 130 determines that the projection position S5 is located in the first quadrant block Qu1. Therefore, after the control unit 130 controls the printing head 110 to complete printing the layer object located at the position P5, the control unit 130 controls the printing head 110 to move toward the second quadrant block Qu2, the third quadrant block Qu3 or the fourth quadrant block Qu4 by a predetermined distance.

In other words, the control unit 130 can control the printing head 110 to move toward the second quadrant block Qu2 along a first direction 777 by the predetermined distance. The control unit 130 can also control the printing head 110 to move toward the third quadrant block Qu3 along a first direction 776 by the predetermined distance. The control unit 130 can also control the printing head 110 to move toward the fourth quadrant block Qu4 along a first direction 775 by the predetermined distance.

It should be noticed that in the 3D printing apparatus 100, two or more than two motors are generally used to control movement of the printing head 110 on the XY plane. For example, the 3D printing apparatus 100 can use two motors to respectively control movement of the printing head 110 along the X-axis direction and the Y-axis direction. Therefore, in an embodiment, if the control unit 130 sets the first direction as a single axial direction, for example, ±X-axis directions or ±Y-axis directions, the control unit 130 is only required to drive the motor corresponding to the single axial direction to achieve a power saving effect, and decease a chance of malfunction of the motor due to excessive usage. To be specific, in the example of FIG. 7B, the first direction along which the printing head 110 is moved from the first quadrant block Qu1 to the second quadrant block Qu2 has different implementations, though based on a principle of driving the minimum number of motor, the first direction 777 can be set to the horizontal direction (−X-axis direction).

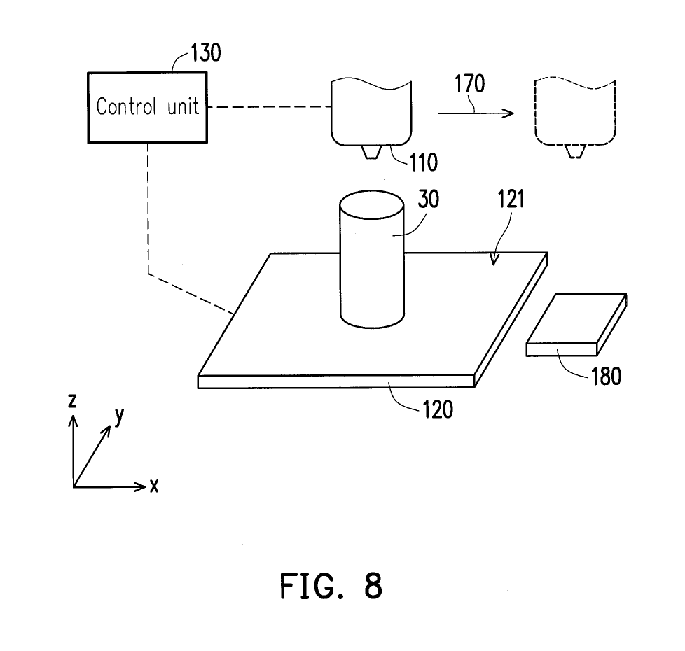

It should be noticed that in the aforementioned embodiments, the moving range of the printing head is limited to be on the top of the carrying surface, though in another embodiment, the control unit can also move the printing head from the top of the carrying surface to another platform. FIG. 8 is a schematic diagram of a 3D printing apparatus according to an exemplary embodiment. Referring to FIG. 8, similar to the embodiment of FIG. 3, the 3D printing apparatus 100 of the present embodiment includes the printing head 110, the platform 120 and the control unit 130. Moreover, the 3D printing apparatus 100 of the present embodiment further includes another platform 180, and the platform 180 is disposed at one side of the platform 120. In the present embodiment, the platform 180 is, for example, a maintaining station of the 3D printing apparatus 100.

Generally, when the printing head starts to print a 3D object, the printing head can be moved to the maintaining station to wait for any instruction related to printing of the 3D object that is sent by the control unit. To be specific, the printing head can be moved to the maintaining station to implement a procedure of cleaning internal components (such as a melting nozzle or a feeding roller) of the printing head.

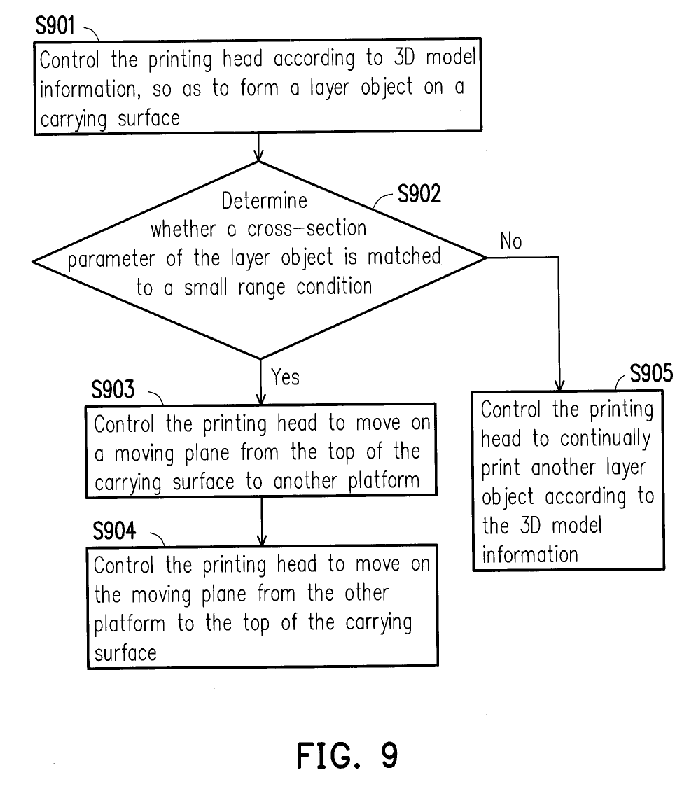

FIG. 9 is a flowchart illustrating a method for controlling printing head according to another exemplary embodiment. The method of the present embodiment is adapted to the 3D printing apparatus of FIG. 8, and detailed steps of the method for controlling printing head of the present embodiment are described below with reference of various components of the 3D printing apparatus 100.

Referring to FIG. 9, in step S901, the control unit 130 controls the printing head 110 to form a layer object on the carrying surface 121 according to 3D model information. In step S902, the control unit 130 determines whether a cross-section parameter of the layer object is matched to a small range condition. If a determination result of the step S902 is negative, in step S905, the control unit 130 controls the printing head 110 to continually print another layer object according to the 3D model information. The above steps S901, S902 and S905 are similar or the same with the steps S401, 402 and S405 of the embodiment of FIG. 4, so that details thereof are not repeated.

A difference between the present embodiment and the aforementioned embodiment is that if the determination result of the step S902 is affirmative, in the step S903, the control unit 130 controls the printing head 110 to move from the top of the carrying surface 112 to the platform 180 along a moving plane. Namely, the step of controlling the printing head 110 to move toward the first direction 170 away from the layer object includes moving the printing head 110 to the platform 180, and the first direction 170 is a direction facing the platform 180. Then, in step S904, the control unit 130 controls the printing head 110 to move back from the platform 180 to the top of the carrying surface 112 along the moving plane to continually print another layer object of the 3D object.

In brief, based on the time spent for moving the printing head 110 to the platform 180, the layer object with a small cross-section can be cured to a certain degree, so as to avoid continually stacking the layer objects that are not cured to the certain degree to cause product deformation. Moreover, when the printing head 110 is moved to the platform 180, a procedure such as printing head cleaning can be executed to avoid remaining a feeding material on the nozzle of the printing head to cause a clogging phenomenon, so as to effectively improve a small range printing quality.

In summary, in the exemplary embodiments, after the 3D printing apparatus completes printing the layer object with a small cross-section area, the printing head is first moved toward a direction away from the layer object by a predetermined distance, and is then moved back to a position suitable for printing another layer object. In this way, based on the time spent for moving the printing head, the layer object with the mall cross-section area may have additional curing time to be cured to a certain degree, so as to avoid continuous addition of a molding material under a state of incomplete curing, and accordingly improve the printing quality of the 3D printing apparatus. Moreover, in the exemplary embodiments, the moving path of the printing head can be determined according to the position of the layer object, so as to control the moving range of the printing head to be within the range of the carrying surface. In this way, the printing head can be effectively controlled to indeed move by a predetermined distance, and meanwhile excessive printing time is avoided.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for controlling printing head, configured to control a moving path of a printing head of a three dimensional (3D) printing apparatus, and the method for controlling printing head comprising:
controlling the printing head according to 3D model information, so as to form a layer object on a carrying surface;
determining whether a cross-section parameter of the layer object is matched to a small range condition;
controlling the printing head to move toward a first direction away from the layer object according to position information of the layer object when the cross-section parameter of the layer object is matched to the small range condition; and
controlling the printing head to move toward a second direction close to the layer object.

2. The method for controlling printing head as claimed in claim 1, wherein the cross-section parameter comprises a total printing time of the layer object, and the step of determining whether the cross-section parameter of the layer object is matched to the small range condition comprises:
determining whether the cross-section parameter of the layer object is matched to the small range condition according to whether the total printing time is smaller than or equal to a time threshold.

3. The method for controlling printing head as claimed in claim 1, wherein the cross-section parameter comprises a total cross-section area of the layer object, and the step of determining whether the cross-section parameter of the layer object is matched to the small range condition comprises:
determining whether the cross-section parameter of the layer object is matched to the small range condition according to whether the total cross-section area is smaller than or equal to an area threshold.

4. The method for controlling printing head as claimed in claim 1, wherein the cross-section parameter comprises a moving distance corresponding to the printing head of the layer object, and the step of determining whether the cross-section parameter of the layer object is matched to the small range condition comprises:
determining whether the cross-section parameter of the layer object is matched to the small range condition according to whether the moving distance is smaller than or equal to a length threshold.

5. The method for controlling printing head as claimed in claim 1, wherein the step of controlling the printing head to move toward the first direction away from the layer object according to the position information of the layer object comprises:
determining a reference point of the layer object; and
determining the first direction according to the reference point, and
controlling the printing head to move toward the first direction by a predetermined distance, such that a moving range of the printing head does not exceeds the top of the carrying surface.

6. The method for controlling printing head as claimed in claim 5, wherein the step of determining the first direction according to the reference point, and controlling the printing head to move toward the first direction by the predetermined distance, such that the moving range of the printing head does not exceeds the top of the carrying surface comprises:
determining whether a projection position of the reference point on the carrying surface is located in an inner block or an outer block of the carrying surface;
controlling the printing head to move on a moving plane toward a center point of the carrying surface by the predetermined distance when the projection position of the reference point is located in the outer block; and
controlling the printing head to move on the moving plane along a first horizontal direction or a second horizontal direction by the predetermined distance when the projection position of the reference point is located in the inner block, wherein the first horizontal direction is opposite to the second horizontal direction.

7. The method for controlling printing head as claimed in claim 6, wherein the inner block is divided into a left part and a right part according to a central dividing line, and the step of controlling the printing head to move on the moving plane along the first horizontal direction or the second horizontal direction by the predetermined distance when the projection position of the reference point is located in the inner block comprises:
controlling the printing head to move on the moving plane toward the central dividing line along the first horizontal direction by the predetermined distance when the projection position is located in the left part of the inner block; and
controlling the printing head to move on the moving plane toward the central dividing line along the second horizontal direction by the predetermined distance when the projection position is located in the right part of the inner block.

8. The method for controlling printing head as claimed in claim 5, wherein the carrying surface is divided into a first quadrant block, a second quadrant block, a third quadrant block and a fourth quadrant block by a horizontal dividing line and a vertical dividing line, and the step of determining the first direction according to the reference point, and controlling the printing head to move toward the first direction by the predetermined distance, such that the moving range of the printing head does not exceeds the top of the carrying surface comprises:
determining whether a projection position of the reference point on the carrying surface is located in the first quadrant block, the second quadrant block, the third quadrant block or the fourth quadrant block; and
controlling the printing head to move toward the second quadrant block, the third quadrant block or the fourth quadrant block by the predetermined distance when the projection position is located in the first quadrant block.

9. The method for controlling printing head as claimed in claim 1, wherein the step of controlling the printing head to move toward the first direction away from the layer object according to the position information of the layer object comprises:
controlling the printing head to move on a moving plane from the top of the carrying surface to another platform, wherein the first direction is a direction facing the other platform,
wherein the step of controlling the printing head to move toward the second direction close to the layer object comprises:
controlling the printing head to move on the moving plane from the other platform to the top of the carrying surface.

10. The method for controlling printing head as claimed in claim 1, wherein the first direction is opposite to the second direction.

11. A three-dimensional printing apparatus, comprising:
a platform, comprising a carrying surface;
a printing head, disposed above the platform, and configured to move along a moving plane and move along a normal direction of the moving plane; and
a control unit, coupled to the platform and the printing head, and controlling the printing head to form a layer object on the carrying surface according to 3D model information, and determining whether a cross-section parameter of the layer object is matched to a small range condition,
wherein when the cross-section parameter of the layer object is matched to the small range condition, the control unit controls the printing head to move toward a first direction away from the layer object according to position information of the layer object, and controls the printing head to move toward a second direction close to the layer object.

12. The three-dimensional printing apparatus as claimed in claim 11, wherein the cross-section parameter comprises a total printing time of the layer object, and the control unit determines whether the cross-section parameter of the layer object is matched to the small range condition according to whether the total printing time is smaller than or equal to a time threshold.

13. The three-dimensional printing apparatus as claimed in claim 11, wherein the cross-section parameter comprises a total cross-section area of the layer object, and the control unit determines whether the cross-section parameter of the layer object is matched to the small range condition according to whether the total cross-section area is smaller than or equal to an area threshold.

14. The three-dimensional printing apparatus as claimed in claim 11, wherein the cross-section parameter comprises a moving distance corresponding to the printing head of the layer object, and the control unit determines whether the cross-section parameter of the layer object is matched to the small range condition according to whether the moving distance is smaller than or equal to a length threshold.

15. The three-dimensional printing apparatus as claimed in claim 11, wherein the control unit determines a reference point of the layer object, and the control unit determines the first direction according to the reference point, and controls the printing head to move toward the first direction by a predetermined distance, such that a moving range of the printing head does not exceeds the top of the carrying surface.

16. The three-dimensional printing apparatus as claimed in claim 15, wherein the control unit determines whether a projection position of the reference point on the carrying surface is located in an inner block or an outer block of the carrying surface,
wherein when the projection position of the reference point is located in the outer block, the control unit controls the printing head to move on a moving plane toward a center point of the carrying surface by the predetermined distance,
wherein when the projection position of the reference point is located in the inner block, the control unit controls the printing head to move on the moving plane along a first horizontal direction or a second horizontal direction by the predetermined distance, wherein the first horizontal direction is opposite to the second horizontal direction.

17. The three-dimensional printing apparatus as claimed in claim 16, wherein the inner block is divided into a left part and a right part according to a central dividing line,
wherein when the projection position is located in the left part of the inner block, the control unit controls the printing head to move on the moving plane toward the central dividing line along the first horizontal direction by the predetermined distance,
wherein when the projection position is located in the right part of the inner block, the control unit controls the printing head to move on the moving plane toward the central dividing line along the second horizontal direction by the predetermined distance.

18. The three-dimensional printing apparatus as claimed in claim 15, wherein the carrying surface is divided into a first quadrant block, a second quadrant block, a third quadrant block and a fourth quadrant block by a horizontal dividing line and a vertical dividing line,
wherein the control unit determines whether a projection position of the reference point on the carrying surface is located in the first quadrant block, the second quadrant block, the third quadrant block or the fourth quadrant block, and when the projection position is located in the first quadrant block, the control unit controls the printing head to move toward the second quadrant block, the third quadrant block or the fourth quadrant block by the predetermined distance.

19. The three-dimensional printing apparatus as claimed in claim 11, further comprising another platform disposed at one side of the platform,
wherein when the cross-section parameter of the layer object is matched to the small range condition, the control unit controls the printing head to move on a moving plane from the top of the carrying surface to the other platform, and controls the printing head to move on the moving plane from the other platform to the top of the carrying surface, wherein the first direction is a direction facing the other platform,

20. The three-dimensional printing apparatus as claimed in claim 11, wherein the first direction is opposite to the second direction.
